(19) United States
(12) Patent Application Publication
(10) Pub. No.: US 2022/0189420 A1
(43) Pub. Date: Jun. 16, 2022

(54) IMAGE DISPLAY APPARATUS AND IMAGE DISPLAY METHOD

(71) Applicant: Sharp Display Technology Corporation, Kameyama City (JP)

(72) Inventors: Masamitsu KOBAYASHI, Kameyama City (JP); Takafumi MIURA, Kameyama City (JP); Masafumi YASHIKI, Kameyama City (JP)

(21) Appl. No.: 17/529,912

(22) Filed: Nov. 18, 2021

(30) Foreign Application Priority Data
Dec. 10, 2020 (JP) 2020-204932

(51) Int. Cl. G09G 3/34; G09G 3/36

(52) U.S. Cl. CPC G09G 3/3413; G09G 3/342; G09G 2320/064; G09G 2310/0235; G09G 3/36

(57) ABSTRACT

An image display apparatus includes a display panel including multiple pixels, a backlight including multiple white-light light sources, a panel driving circuit, a backlight driving circuit, and a determination circuit determining image data. The white-light light sources have characteristics that cause afterglow of a particular color to persist longer than afterglow of another color. The backlight driving circuit segments the backlight into multiple areas and drives the backlight such that a time duration of performing control to cause the areas to sequentially be in a light-emission state at mutually different timings alternates with a time duration of performing control to cause all the areas to be in a non-light-emission state. The determination circuit determines a determination value indicating a degree of inclusion at which achromatic data is included in the image data and determines a light-emission start timing of each of the areas in accordance with the determination value.

### BACKGROUND

### 1. Field

The present disclosure relates to image display apparatuses and, in particular, to an image display apparatus having a backlight.

### 2. Description of the Related Art

Liquid-crystal display apparatuses are widely used as thin, light-weight, low-power consuming image display apparatuses. A liquid-crystal panel included in the liquid-crystal display apparatus is a non-light emitting display panel. For this reason, many liquid-crystal display apparatuses include backlights emitting light onto the rear surface of the liquid-crystal panel. The liquid-crystal display apparatus having the backlight is described below as an example of the image display apparatus having the backlight.

The liquid-crystal display apparatus may have video display performance that becomes lower if the backlight is continuously operated. A flashing backlight driving method is known as a method to increase the video display performance. In the liquid-crystal display apparatus performing the flashing backlight driving method, a light-emission duration of the backlight is set during one frame period and the backlight is active only during the light-emission duration. The flashing backlight driving method is also referred to as an impulse backlight driving method.

FIG. 10 illustrates operation timings of the liquid-crystal display apparatus performing the flashing backlight driving method. Referring to FIG. 10, broken slant lines denote a write timing on each of pixels and a completion timing of the response of each of the pixels. A slant-line hatched portion denotes the light-emission duration of the backlight. Luminance of the pixels varies during a time period from the start of the writing on each of the pixels to the completion of the response of each of the pixels (hereinafter referred to as rewrite time) but does not vary during a time period from the completion of the response of the pixel to the next writing on the pixel (confirmation time). Referring to FIG. 10, the backlight starts to emit light before the completion of the response of pixels at the p-th row to n-th row. For this reason, a display fault called ghost occurs at the p-th to n-th rows on a display screen, leading to lower video display performance.

A scan backlight driving method is available to address the above problem. In the liquid-crystal display apparatus performing the scan backlight driving method, the backlight is segmented into multiple areas and the multiple areas are controlled such that the areas are sequentially one after another in a light-emission state at different timings.

FIG. 11 illustrates operation timings of the liquid-crystal display apparatus performing the scan backlight driving method. Referring to FIG. 11, the backlight is segmented into 20 areas. Each area starts to emit light after the completion of the responses of the pixels at multiple rows corresponding to the area. In this way, the ghost may be controlled, leading to increased video display performance.

The scan backlight driving method has a problem of luminance unevenness on the display screen where a bright line and a dark line are displayed at a location on the display screen corresponding to a border of the areas. The liquid-crystal display apparatus performing the scan backlight driving method has typically the backlight that is designed to leak light from one area to another area to reduce the luminance unevenness. However, if leakage light enters an area within a rewrite time, ghost occurs at the video edge. Referring to FIG. 11, in the vicinity of an end portion of the light-emission duration of a 20th area (bottommost area), another area is within the rewrite time. If light from the 20th area enters another area, ghost occurs at the video edge at the location on the display screen corresponding to that area.

Another method is available to increase color reproducibility of emission light from the backlight (hereinafter referred to as backlight light). This method employs KSF phosphor as a red-light phosphor included in a white-light light emitting diode (LED) in the backlight. The KSF phosphor is fluoride phosphor having a composition of K₂SiF₆:Mn⁴⁺ or K₂TiF₆:Mn⁴⁺.

The liquid-crystal display apparatuses performing the scan backlight driving method are described in Japanese Patent No. 5919992 and Japanese Patent No. 4540940. According to Japanese Patent No. 5919992, in order to control ghost in the liquid-crystal display apparatus performing the scan backlight driving method, the length of time from the completion of the writing on pixels to the emission of a corresponding area is nonlinearly varied in a scanning order of the areas while a time duration of the emission and an amount of light at the emission are varied in response to the location of each area. Japanese Patent No. 4540940 describes a backlight driver apparatus that, in scan backlight driving, adjusts a drive voltage and phase of a backlight during one frame period in response to the occurrence state of a block including a moving image and a sharp outline of the moving image during the one frame period. For example, a backlight including white-light LED with KSF phosphor is described in International Publication No. 2015/68513.

It is contemplated that a backlight including a white-light LED with KSF phosphor is used to improve the color reproducibility of backlight light in the liquid-crystal apparatus performing the flashing backlight driving or scan backlight driving. The flashing backlight driving and scan backlight driving are performed based on the premise that the backlight (or a backlight area) immediately switches from a light-emission state to a non-light-emission state.

The white-light LED with the KSF phosphor has the property that the afterglow of a red color persists longer than the afterglow of another color (such as of green or blue). If a liquid-crystal display apparatus performing the flash backlight driving or the scan backlight driving is implemented using the backlight including the white-light LED with the KSF phosphor, the red afterglow of the backlight light persists longer and a viewer visibly recognizes a video edge having a mixture of red color and cyan color.

In the liquid-crystal display apparatus with the backlight starting to emit light during a rewrite time, ghost is created on a display screen because of insufficient response time. The viewer visibly recognizes both a video edge with a mixture of red and cyan colors and ghost in the liquid-crystal display apparatus with the backlight including the white-light LED with the KSF phosphor starting to emit light during the rewrite time.

It is desirable to provide an image display apparatus and an image display method that preclude a viewer from visibly recognizing ghost and a video edge mixed with a particular color.

### SUMMARY

According to an aspect of the disclosure, there is provided an image display apparatus including: a display panel including multiple pixels; a backlight including multiple white-light light sources and emitting light onto a rear surface of the display panel; a panel driving circuit driving the display panel; a backlight driving circuit driving the backlight; and a determination circuit determining image data that is input. The white-light light sources have persistence characteristics that cause afterglow of a particular color to persist longer than afterglow of another color. The backlight driving circuit segments the backlight into multiple areas and drives the backlight in a manner such that a time duration of performing control to cause the areas to sequentially be in a light-emission state at mutually different timings alternates with a time duration of performing control to cause all the multiple areas to be in a non-light-emission state. The determination circuit determines a determination value indicating a degree of inclusion at which achromatic data is included in the image data and determines a light-emission start timing of each of the areas in accordance with the determination value.

According to another aspect of the disclosure, there is provided an image display method of an image display apparatus including a display panel including multiple pixels and a backlight including multiple white-light light sources and emitting light onto a rear surface of the display panel. The image display method includes: driving the display panel; driving the backlight; and determining image data that is input. The white-light light sources have persistence characteristics that cause afterglow of a particular color to persist longer than afterglow of another color. The driving of the backlight includes segmenting the backlight into multiple areas and driving the backlight in a manner such that a time duration of performing control to cause the areas to sequentially be in a light-emission state at mutually different timings alternates with a time duration of performing control to cause all the multiple areas to be in a non-light-emission state. The determining of the image data includes determining a determination value indicating a degree of inclusion at which achromatic data is included in the image data and determining a light-emission start timing of each of the areas in accordance with the determination value.

### BRIEF DESCRIPTION OF THE DRAWINGS

FIG. 1 is a block diagram illustrating a configuration of a liquid-crystal display apparatus of an embodiment;

FIG. 2 illustrates a segmentation method of a backlight of the liquid-crystal display apparatus in FIG. 1;

FIG. 3 illustrates a configuration of a white-light LED included in a backlight of the liquid-crystal display apparatus in FIG. 1;

FIG. 4 illustrates operation timings of the liquid-crystal display apparatus in FIG. 1;

FIG. 5 illustrates portions of FIG. 4 that are expanded and contracted;

FIG. 6A illustrates operation timings of the liquid-crystal display apparatus in FIG. 1 during a coloring control top-priority duration;

FIG. 6B illustrates operation timings of the liquid-crystal display apparatus during a video display performance top-priority duration;

FIG. 7 is a flowchart illustrating a process of a determination circuit in the liquid-crystal display apparatus in FIG. 1;

FIG. 8 illustrates a video blur waveform of a comparative liquid-crystal display apparatus;

FIG. 9A illustrates a video blur waveform when the liquid-crystal display apparatus in FIG. 1 operates during a coloring control priority duration;

FIG. 9B illustrates a video blur waveform when the liquid-crystal display apparatus in FIG. 1 operates during a video display performance priority duration;

FIG. 10 illustrates operation timings of a liquid-crystal display apparatus performing flashing backlight driving; and

FIG. 11 illustrates operation timings of a liquid-crystal display apparatus performing scan backlight driving.

### DESCRIPTION OF THE EMBODIMENTS

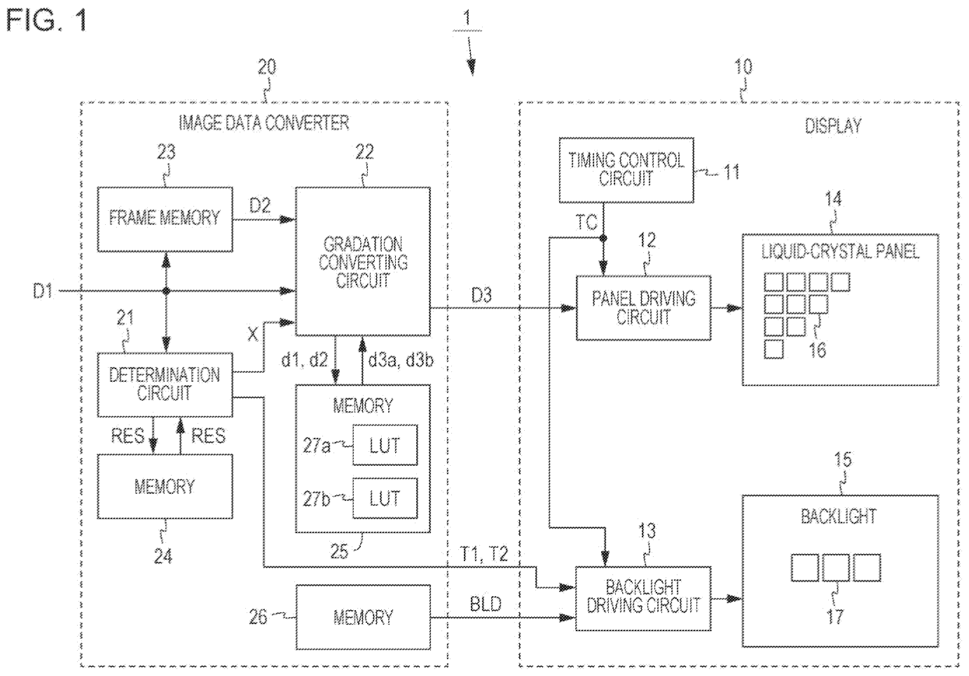

FIG. 1 is a block diagram illustrating a configuration of a liquid-crystal display apparatus 1 of an embodiment. The liquid-crystal display apparatus 1 in FIG. 1 includes a display 10 and image data converter 20. The display 10 includes a timing control circuit 11, panel driving circuit 12, backlight driving circuit 13, liquid-crystal panel 14, and backlight 15. The image data converter 20 includes a determination circuit 21, gradation converting circuit 22, frame memory 23, and memories 24 through 26.

Image data D1 is input to the liquid-crystal display apparatus 1 from the outside. The image data converter 20 determines image data D3 by performing gradation conversion for overdrive on the image data D1. The image data converter 20 outputs to the display 10 light-emission start timings T1 and T2 and backlight data BLD, as drive data for the backlight 15. In response to the light-emission start timings T1 and T2 and backlight data BLD, the display 10 causes the backlight 15 to emit light while displaying an image on the liquid-crystal panel 14 in response to the image data D3.

The liquid-crystal panel 14 includes multiple pixels 16 that are two-dimensionally arranged. The backlight 15 includes multiple white-light light emitting diodes (LEDs) 17 serving as multiple white-light light sources. The backlight 15 further includes a light-guiding plate and the white-light LEDs 17 are one-dimensionally arranged along the side of the light-guiding plate. The backlight 15 is arranged on the backside of the liquid-crystal panel 14 and emits light on the rear surface of the liquid-crystal panel 14.

The timing control circuit 11 outputs a timing control signal TC to the panel driving circuit 12 and backlight driving circuit 13. The panel driving circuit 12 drives the liquid-crystal panel 14 in response to the timing control signal TC and image data D3. The panel driving circuit 12 sequentially writes image data included in the image data D3 on the pixels 16 on each row. The writing operation on the pixels 16 is performed from to top to bottom on a display screen. The backlight driving circuit 13 drives the backlight 15 in response to the timing control signal TC, light-emission start timings T1 and T2, and backlight data BLD. The backlight driving circuit 13 segments the backlight 15 into two areas and drives the two areas.

The image data D1 of one frame includes image data corresponding to the pixels 16 of the liquid-crystal panel 14. The determination circuit 21 sorts the image data into achromatic data and chromatic data. The determination circuit 21 determines whether a count of the achromatic data included in the image data D1 of one frame is higher than a threshold and outputs binary determination results RES. The memory 24 stores the determination results RES in the order of output. Based on latest M determination results RES stored on the memory 24 (M is 2 or a higher integer), the determination circuit 21 determines as a determination value X the ratio of frames, each frame having the count of the achromatic data higher than the threshold, to the latest M frame. The determination value X is 0 or higher and 1 or lower. The determination circuit 21 determines the light-emission start timings T1 and T2 of the backlight 15 in accordance with the determination value X.

The memory 25 stores beforehand two look-up tables (LUTs) for overdrive, 27a and 27b. The frame memory 23 stores the image data D1 of at least one frame. The gradation converting circuit 22 determines the image data D3 by performing gradation conversion for overdrive on the input image data D1 serving as image data of a current frame and image data D2 read from the frame memory 23 serving as image data of a preceding frame. The gradation conversion is performed using LUTs 27a and 27b stored on the memory 25.

The memory 26 stores beforehand the backlight data BLD used to determine the luminance of the backlight 15. The backlight data BLD includes a duty factor representing a ratio of light-emission time of the white-light LEDs 17 and a current value representing a current flowing through the white-light LEDs 17.

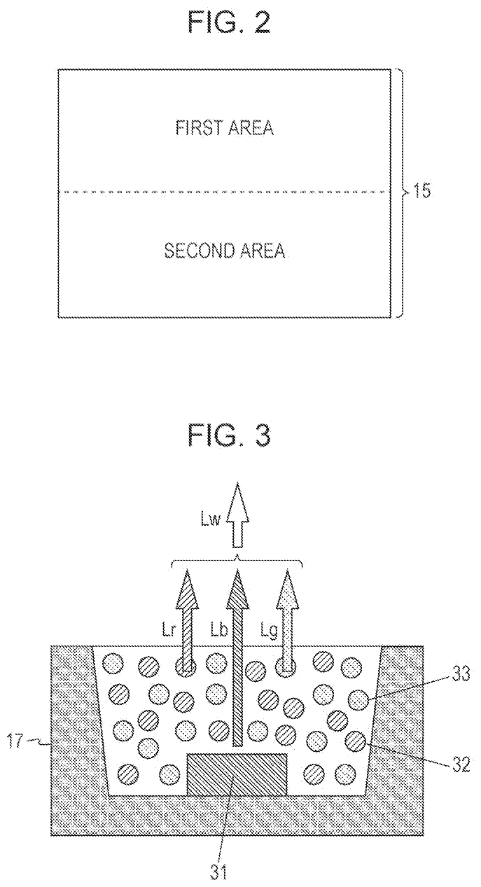

FIG. 2 illustrates a segmentation method of the backlight 15. Referring to FIG. 2, the backlight 15 is segmented into two areas in the same direction as the order of writing on the pixels 16 (namely, in a direction from top to bottom). The top half of the display screen is referred to as a first area and the bottom half of the display screen is referred to as a second area.

FIG. 3 illustrates the configuration of the white-light LED 17 included in the backlight 15. Referring to FIG. 3, the white-light LED 17 includes a blue-light LED 31, red-light phosphor 32, and green-light phosphor 33. The blue-light LED 31 emits blue light Lb. The red-light phosphor 32 converts part of the energy of the blue light Lb into red light Lr. The green-light phosphor 33 converts part of the energy of the blue light Lb into green light Lg. The white-light LED 17 emits white light Lw that is a combination of the red light Lr, green light Lg, and blue light Lb.

The liquid-crystal display apparatus 1 employs KSF phosphor as the red-light phosphor 32 to increase the color reproducibility of the backlight light (emission light from the backlight 15). Red light created using the KSF phosphor has the property that the afterglow persists longer. The white-light LED 17 employing the KSF phosphor thus has the property that the afterglow of the red light persists longer than the afterglow of the other colors (green and blue). After the backlight driving circuit 13 switches the first area from the light-emission state to the non-light-emission state, the afterglow of the red light of the backlight light persists longer in the first area. If the afterglow of the red light of the backlight light persists longer in the liquid-crystal display apparatus performing the scan backlight driving, the viewer visibly recognizes the video edge mixed with red and cyan colors.

To address this problem, the backlight driving circuit 13 drives the backlight 15 in a manner such that a time duration of performing control to cause the two areas to sequentially be in a light-emission state (hereinafter referred to as a partial light-emission duration) alternates with a time duration of performing control to cause all the two areas to be in a non-light-emission state (hereinafter referred to as an overall non-light-emission duration). In the following discussion, this driving is referred to as alternate scan backlight driving and an area count included in the backlight 15 is N. The area count N equals the number of partial light-emission durations within one frame period and equals the number of overall non-light-emission durations within one frame period. In the liquid-crystal display apparatus 1, N is 2.

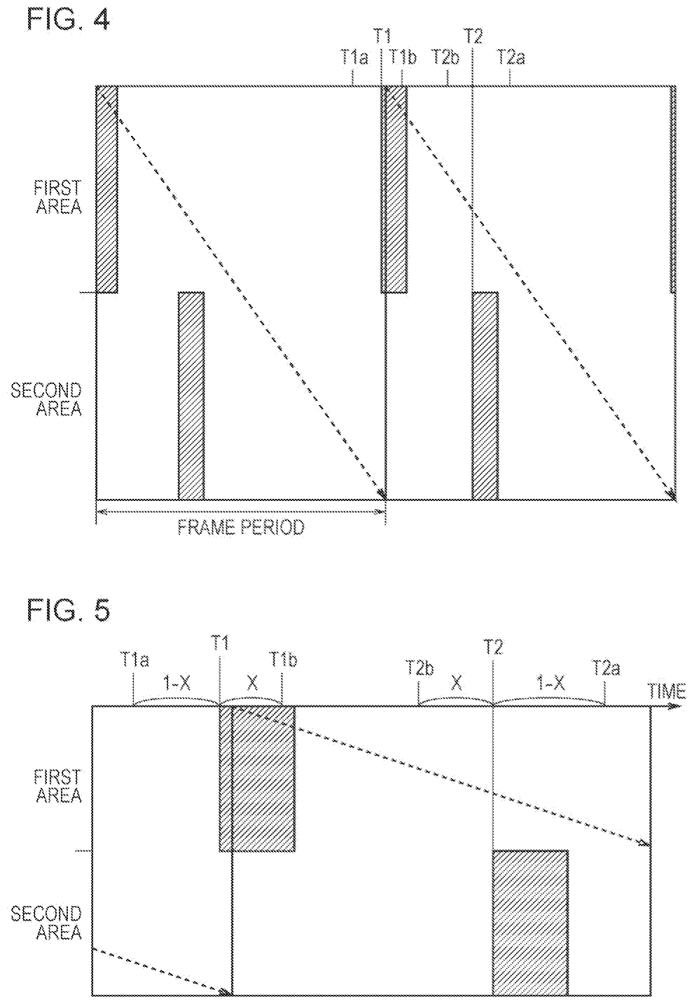

FIG. 4 illustrates operation timings of the liquid-crystal display apparatus 1. FIG. 5 illustrates portions of FIG. 4 that are expanded in a horizontal direction and contracted in a vertical direction. Referring to FIGS. 4 and 5, broken lines denote write timings on the pixels 16 and slant-line hatched portions denote the light-emission duration of the backlight 15. The time while the first area or second area is in the light-emission state is the partial light-emission duration and the time while both the first area and second area are in the non-light-emission state is the overall non-light-emission duration.

The panel driving circuit 12 performs writing on the pixels 16 at the top row of the liquid-crystal panel 14 (a row corresponding to the top end of a display screen) at the start of the frame period. The panel driving circuit 12 then consecutively performs writing on the pixels 16 at the subsequent rows of the liquid-crystal panel 14. At the end of the frame period, the panel driving circuit 12 performs writing on the pixels 16 at the bottommost row of the liquid-crystal panel 14. In this way, the panel driving circuit 12 starts writing, at the beginning of the frame period, on the pixels 16 on the liquid-crystal panel 14 corresponding to the first area and starts writing, in the middle of the frame period, on the pixels 16 on the liquid-crystal panel 14 corresponding to the second area.

The backlight driving circuit 13 segments the backlight 15 into the first area and second area and causes each of the first area and second area to emit light once within one frame period in response to the light-emission start timings T1 and T2 determined by the determination circuit 21. Referring to FIG. 4, the first area starts emitting light at the light-emission start timing T1 and the second area starts emitting light at the light-emission start timing T2. The length of the light-emission duration of the first area is equal to the length of the light-emission duration of the second area.

If the degree of inclusion at which the achromatic data is included in the image data D1 is higher (if the determination value X is higher), the viewer may be more likely to observe a video edge mixed with red and cyan colors. In this case, controlling coloring is more desirably prioritized. On the other hand, if the degree of inclusion at which the achromatic data is included in the image data D1 is lower (if the determination value X is lower), the viewer is less likely to observe the video edge mixed with red and cyan colors. In this case, improving the video display performance is more desirably prioritized.

The duration that the determination value X is higher than a predetermined value is referred to as a “coloring control priority duration.” The duration that the determination value X is lower than the predetermined value is referred to as a “video display performance priority duration.” The duration that the determination value X is at maximum (X=1) is referred to as a “coloring control top-priority duration.” The duration that the determination value X is at minimum (X=0) is referred to as a “video display performance top-priority duration.”

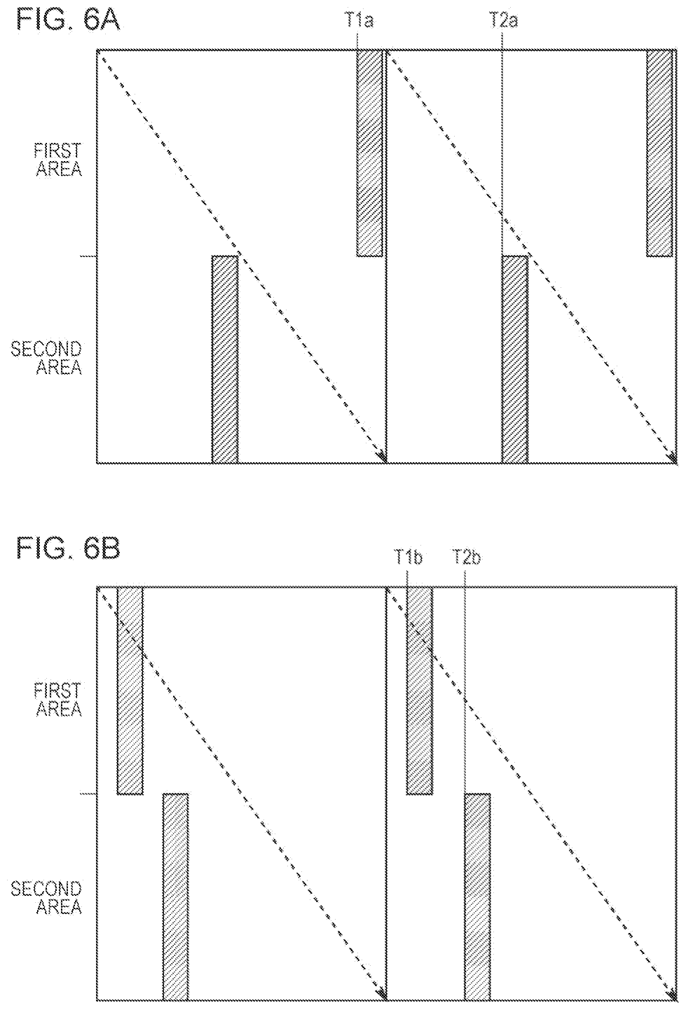

FIG. 6A illustrates operation timings of the liquid-crystal display apparatus 1 during the coloring control top-priority duration. FIG. 6B illustrates operation timings of the liquid-crystal display apparatus during the video display performance top-priority duration. The liquid-crystal display apparatus 1 operates at predetermined timings including a light-emission start timing T1a of the coloring control top-priority duration of the first area, light-emission start timing T2a of the coloring control top-priority duration of the second area, light-emission start timing T1b of the video display performance top-priority duration of the first area, and light-emission start timing T2b of the video display performance top-priority duration of the second area.

Let FT represent the length of one frame period, and light-emission start timings T1a and T2a are calculated to satisfy the following equation (1):

T2a−T1a=FT/2 (1)

Light-emission start timings T1b and T2b may be desirably determined in view of the response speed of the pixels. The light-emission start timings T1a, T2a, T1b, and T2b are determined to satisfy the following equation (2):

T2b−T1b<T2a−T1a. (2)

A difference between the light-emission start timing of the first area and the light-emission start timing of the second area with the first area and second area sequentially set to be in the light-emission state is higher during the coloring control top-priority duration than during the video display performance top-priority duration.

In accordance with the determination value X and the light-emission start timings T1a, T2a, T1b, and T2b, the determination circuit 21 determines the light-emission start timing T1 of the first area and the light-emission start timing T2 of the second area in view of the following equations (3) and (4) (with reference to FIG. 5):

T1=X×T1a+(1−X)×T1b (3)

T2=X×T2a+(1−X)×T2b (4)

The determination circuit 21 determines the light-emission start timing T1 of the first area by dividing proportionally by the determination value X the light-emission start timing T1a of the coloring control top-priority duration of the first area and the light-emission start timing T1b of the video display performance top-priority duration of the first area. The determination circuit 21 furthermore determines the light-emission start timing T2 of the second area by proportionally dividing by the determination value X the light-emission start timing T2a of the coloring control top-priority duration of the second area and the light-emission start timing T2b of the video display performance top-priority duration of the second area.

As the determination value X is higher, the difference between the light-emission start timing T1 of the first area and the light-emission start timing T2 of the second area becomes larger when the first area and second area are sequentially set to be in the light-emission state. In this way, as the determination value X is higher, the determination circuit 21 causes to be larger a difference between the light-emission timings of multiple areas when the multiple areas are controlled to be subsequently in the light-emission state.

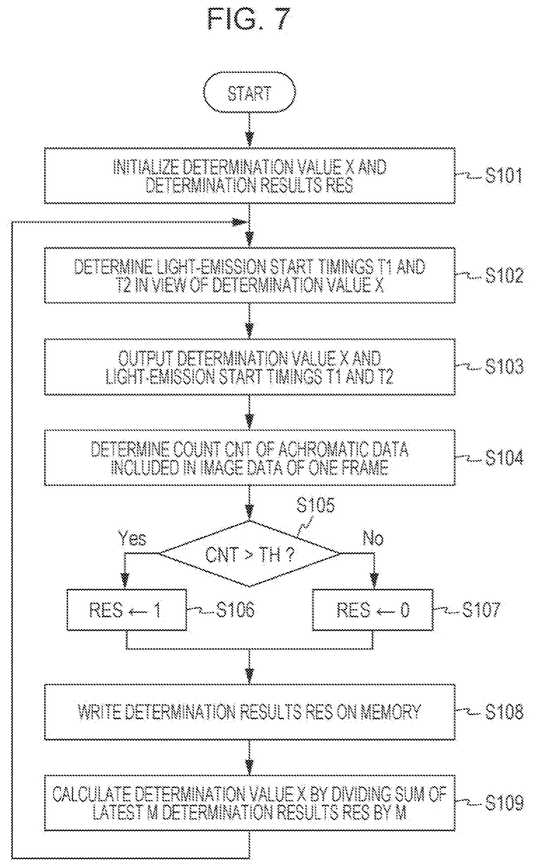

FIG. 7 is a flowchart illustrating the process performed by the determination circuit 21. Referring to FIG. 7, the determination circuit 21 initializes the determination value X and the determination results RES stored on the memory 24 (step S101). The determination circuit 21 then performs steps in S102 through S109 on the image data D1 of one frame.

In step S102, the determination circuit 21 determines the light-emission start timings T1 and T2 in accordance with equations (3) and (4) in view of the determination value X and the light-emission start timings T1a, T2a, T1b, and T2b. The determination value X used in step S102 may be the value initialized in step S101 or determined in step S109.

The determination circuit 21 outputs the determination value X and light-emission start timings T1 and T2 determined in step S102 (step S103). The determination value X is output to the gradation converting circuit 22 and is used by the gradation converting circuit 22 in gradation conversion. The light-emission start timings T1 and T2 are output to the backlight driving circuit 13 and is used by the backlight driving circuit 13 when the backlight driving circuit 13 drives the backlight 15.

The determination circuit 21 determines a count CNT of achromatic data included in the image data D1 of one frame (step S104). In accordance with a predetermined criteria, the determination circuit 21 sorts the image data included in the image data D1 into achromatic data and chromatic data. For example, the determination circuit 21 may sort, into the achromatic data, the image data including a red component, a green component, and a blue component, all equal to each other. Alternatively, the determination circuit 21 may sort, into achromatic data, the image data including a red component, a green component, and a blue component with a difference therebetween lower than a predetermined value.

The determination circuit 21 determines whether the count CNT is higher than a threshold TH (step S105). If yes path is followed, processing proceeds to step S106 and if no path is followed, processing proceeds to step S107. In step S106, the determination circuit 21 sets the determination results RES to 1. In step S107, the determination circuit 21 sets the determination results RES to 0. The determination circuit 21 writes the determination results RES set in step S106 or S107 onto the memory 24 (step S108).

The determination circuit 21 determines the determination value X by dividing a sum of latest M determination results RES stored on the memory 24 by the number M of frames (step S109). The determination value X represents a ratio of fames, each having the count CNT of the achromatic data higher than the threshold TH, to the latest M frames. The determination circuit 21 returns to step S102. The determination value X determined in step S109 is used when the light-emission start timings T1 and T2 are determined next in step S102.

Instead of determining the count CNT of the achromatic data included in the image data D1 of one frame in step S104, the determination circuit 21 may select multiple pieces of representative image data from the image data D1 of one frame and determine the count of the achromatic data out of the representative image data. Instead of dividing the sum of M latest determination results RES by the number M of frames (namely, instead of performing simple averaging of M latest determination results RES) in step S109, the determination circuit 21 may weighted-average M determination results RES with a larger weight applied to a later result RES.

The determination circuit 21 determines the determination value X in accordance with the M determination results RES related to the image data D1 of M frames. In this way, a sharp change in the determination value X may thus be controlled. The number M of frames may be set to within a range from several frames to several hundreds of frames in view of image discomfort occurring on the display screen.

If the threshold TH is set to 0, and if at least a single piece of the achromatic data is included in the image data D1 of one frame, then the determination results RES is 1. For this reason, the determination value X is 1 in many cases and the light-emission timings T1 and T2 respectively become closer to light-emission timings T1a and T2a (FIG. 6A). If the threshold TH is set to (number of pixels of the liquid-crystal panel 14-1), the determination results RES become 1 only if all image data included in the image data D1 of one frame is achromatic data. The determination value X is 0 in many cases for this reason and the light-emission timings T1 and T2 respectively become closer to light-emission timings T1b and T2b (FIG. 6B). By controlling the threshold TH in this way, the light-emission start timings T1 and T2 may be adjusted to any value between the light-emission timings T1a and T2a and the light-emission timings T1b and T2b.

Referring to FIG. 7, before the determination value X is determined in view of the image data D1 that is input, the determination circuit 21 determines the light-emission start timings T1 and T2 in accordance with the determination value X determined for the image data D1 down to a previous frame. A delay involved in the process in FIG. 7 may thus be controlled. Alternatively, after determining the determination value X in view of the input image data D1 that is input, the determination circuit 21 may determine the light-emission start timings T1 and T2 in accordance with the determined determination value X.

The gradation conversion for overdrive to be performed by the image data converter 20 is described below. As previously described, the memory 25 pre-stores two LUTs 27a and 27b for overdrive. The LUTs 27a and 27b store post-conversion-gradation values corresponding to combinations of a gradation value of a current frame and a gradation value of a preceding frame. The LUT 27a stores a post-conversion-gradation value during the coloring control top-priority duration and the LUT 27b stores a post-conversion-gradation value during the video display performance top-priority duration. The post-conversion-gradation value during the coloring control top-priority duration emphasizes more a time change of the image data D1 than the post-conversion-gradation value during the video display performance top-priority duration.

As previously described, the gradation converting circuit 22 determines the image data D3 by performing the gradation conversion for overdrive on the input image data D1 serving as the image data of the current frame and the image data D2 read from the frame memory 23 serving as the image data of the preceding frame. Let d1, d2, and d3 respectively represent gradation values of color components of the image data included in the image data D1, D2, and D3. The gradation converting circuit 22 reads a gradation value d3a responsive to the gradation values d1 and d2 from the LUT 27a and a gradation value d3b responsive to the gradation values d1 and d2 from the LUT 27b. The gradation converting circuit 22 determines the gradation value d3 in accordance with equation (5) in view of the determination value X determined by the determination circuit 21 and the gradation values d3a and d3b:

d3=X×d3a+(1−X)×d3b (5)

As the degree of inclusion at which the achromatic data is included in the image data D1 is higher (specifically, as the determination value X is higher, namely, coloring is to be controlled with higher priority), the degree of emphasis on the time change of the image data D1 (the degree of overdrive) is higher. On the other hand, as the degree of inclusion at which the achromatic data is included in the image data D1 is lower (specifically, as the determination value X is lower, namely, display performance is to be improved with higher priority), the degree of emphasis on the time change of the image data D1 is lower. By switching the degree of overdrive appropriately in response to the determination value X in this manner, an insufficiency of the response speed of the liquid-crystal panel 14 may thus be reduced.

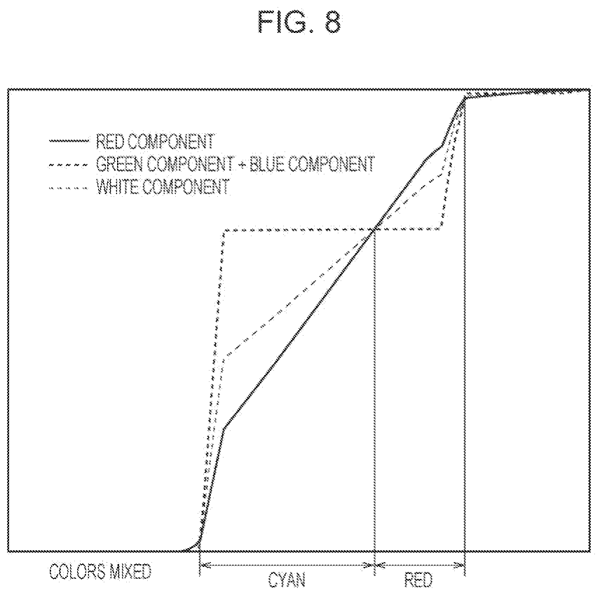

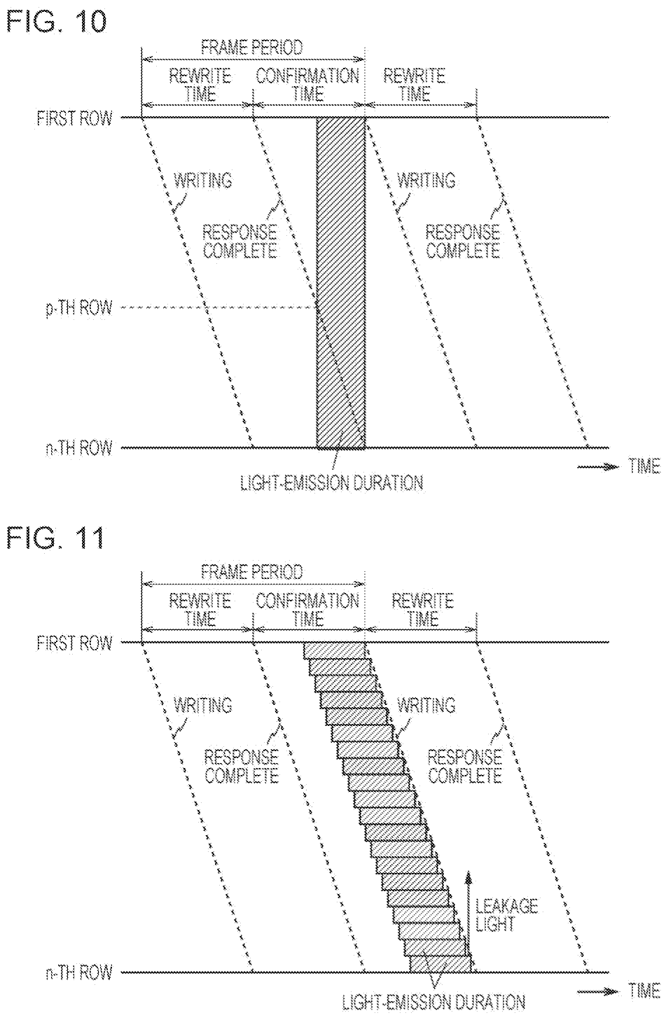

A comparative liquid-crystal display apparatus (FIG. 10) may now be described below. The comparative liquid-crystal display apparatus has a backlight having persisting afterglow and performs flashing backlight driving. The flashing backlight driving corresponds to the scan backlight driving with the number of areas being 1. FIG. 8 illustrates a video blur waveform of the comparative liquid-crystal display apparatus. Referring to FIG. 8, if the display screen includes a dark area and a light area, a video blur waveform occurs at or near a border between the two areas. The video blur waveform includes a red component, green component, and blue component. The backlight is assumed to start lighting before completion of the response of part of the pixels (for example, pixels at p-th row through n-th row in FIG. 10).

The border portion between the two areas looks gray to the viewer. A portion having a red component at a higher quantity looks mixed with red to the viewer. A portion having green and blue components at a higher quantity looks mixed with cyan to the viewer.

Looking at the display screen of the comparative liquid-crystal display apparatus, the viewer views ghost occurring in response to the degree of response insufficiency and ghost occurring in response to the number of light emissions during one frame period. Let P represent the number of ghosts responsive to the degree of response insufficiency and N, the number of areas, and the number of visible ghosts is (N−1+P). Since a difference between the red component and the green component and a difference between the red component and the blue component increase in a video blur region (a region changing from dark to white), the viewer visibly recognizes red and cyan, higher in chroma, with respect to an achromatic edge.

In contrast, as the number of ghosts (namely, N−1+P) is higher in the liquid-crystal display apparatus 1, a difference between a video blur waveform of a red color and a video blur waveform of another color becomes smaller. Where the viewer visibly recognizes the video edge, red, green, and blue changes at a higher frequency. The liquid-crystal display apparatus 1 may thus preclude the viewer from visibly recognizing the video edge mixed with red and cyan.

As the number of ghosts is higher, the liquid-crystal display apparatus 1 may provide more the effect of precluding the viewer from visibly recognizing the video edge mixed with red and cyan. On the other hand, if the number of ghosts increases, the effect of increasing video display performance is reduced. To achieve a balance between the two effects, the number N of areas is set to 2 and the backlight 15 may be configured to reduce the intensity of light of one area while diffusing the light to the far end of another area.

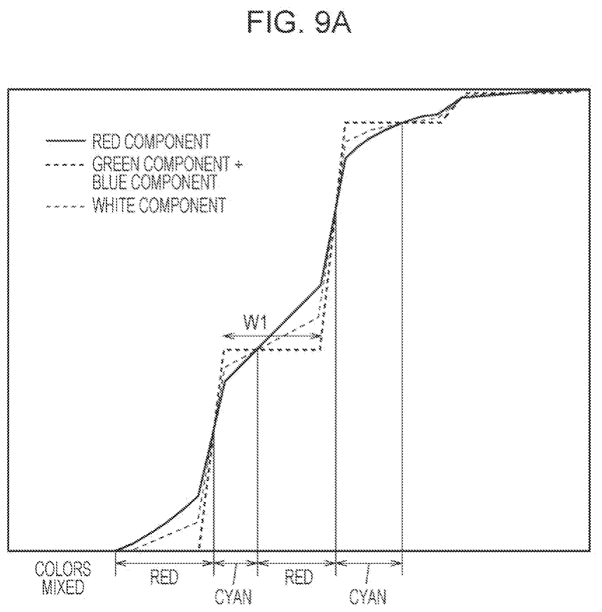

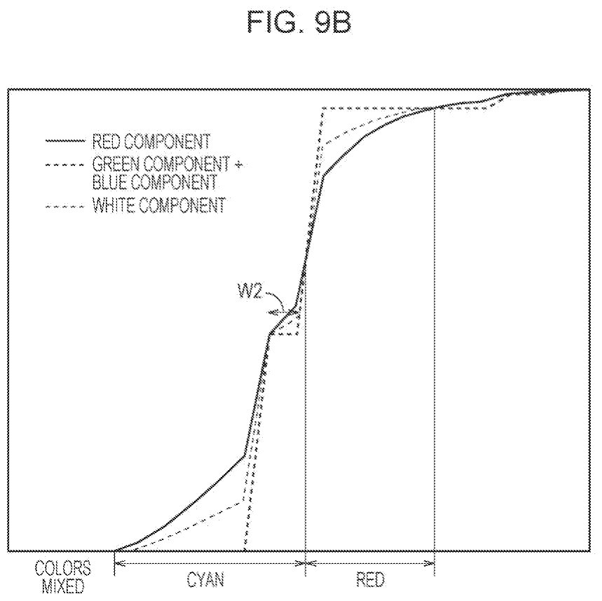

FIG. 9A illustrates a video blur waveform of the liquid-crystal display apparatus 1 during the coloring control priority duration. The video blur waveform in FIG. 9A occurs when the degree of inclusion at which the achromatic data is included in the image data D1 is higher than a predetermined value. The backlight 15 emits light at a timing closer to the timing illustrated in FIG. 6A. The difference between the waveform of the red component and the waveform of each of the green and blue components is smaller in FIG. 9A than in FIG. 8. If the degree of inclusion of the achromatic data is higher, the determination circuit 21 causes a difference between the light-emission start timing T1 of the first area and the light-emission start timing T2 of the second area to be larger when the first area and second area are controlled to alternately be in the light-emission state. In this way, the viewer may thus be precluded from visibly recognizing the coloring in an image, such as an achromatic image, in which the coloring tends to stand out.

FIG. 9B illustrates a video blur waveform of the liquid-crystal display apparatus 1 during the video display performance priority duration. Referring to FIG. 9B, the video blur waveform with the degree of inclusion at which the achromatic data is included in the image data D1 lower than a predetermined value is illustrated. The backlight 15 emits light at a timing closer to the timing in FIG. 6B. The width of a ghost easily visible to the viewer in the center is narrower in FIG. 9B than in FIGS. 8 and 9A (W1>W2). If the degree of inclusion of the achromatic data is lower, the determination circuit 21 causes a difference between the light-emission start timing T1 of the first area and the light-emission start timing T2 of the second area to be smaller when the first area and second area are controlled to alternately be in the light-emission state. In this way, an image, such as a chromatic image, in which coloring is less likely to stand out, may be improved in terms of video display performance and the viewer may be precluded from visibly recognizing the ghost.

The backlight 15 is driven in a manner such that controlling of the coloring is prioritized in an image including a larger amount of achromatic data and having noticeable coloring. The backlight 15 is also driven in a manner such that improvement of the video display performance is prioritized in an image including a large amount of chromatic data and having less noticeable coloring. The liquid-crystal display apparatus 1 switches, in response to the characteristics of the image data D1, between placing priority on controlling of the coloring and placing priority on improvement of the video display performance. The viewer may thus be precluded from visibly recognizing the ghost and the video edge mixed with a particular color. The determination circuit 21 performs the process in FIG. 7, thereby determining the image data D1. A relatively simpler circuit may thus perform the determination, leading to achieving the above-described effects.

The image data converter 20 may be implemented in any method in view of the configuration of the liquid-crystal display apparatus 1. For example, each of the determination circuit 21 and gradation converting circuit 22 may be implemented using a dedicated circuit. Alternatively, the determination circuit 21 and/or the gradation converting circuit 22 may be implemented using a combination of a central processing unit (CPU) and a computer program executed by the CPU. The memories 24 through 26 may be implemented by a single memory.

As previously described, the image display apparatus of the embodiment (the liquid-crystal display apparatus 1) includes the display panel (the liquid-crystal panel 14) including the multiple pixels 16, the backlight 15 including multiple white-light light sources (white-light LEDs 17) and emitting light to the rear surface of the display panel, the panel driving circuit 12 driving the display panel, the backlight driving circuit 13 driving the backlight 15, and the determination circuit 21 determining the image data D1 that is input. The white-light LED has the property that the afterglow of a particular color (such as red) persists longer than the afterglow of another color (such as green or blue). The backlight driving circuit 13 segments the backlight 15 into multiple areas (the first area and second area) and drives the backlight 15 in a manner such that a time duration of performing control to cause the areas to sequentially be in the light-emission state at mutually different timings (partial light-emission duration) alternates with a time duration of performing control to cause all the multiple areas to be in a non-light-emission state (overall non-light-emission duration). The determination circuit 21 determines the determination value X indicative of the degree of inclusion at which the achromatic data is included in the image data D1 and determines the light-emission start timings T1 and T2 of the areas in accordance with the determination value X.

In the image display apparatus of the embodiment, when the afterglow of the particular color of the backlight light persists longer, the backlight 15 is controlled such that the time duration of performing control to cause the areas to sequentially be in the light-emission state alternates with the time duration of performing control to cause all the areas to be in the non-light-emission state. The difference between the video blur waveform of the particular color and the video blur waveform of another color may be reduced, precluding the viewer from visibly recognizing the video edge mixed with the particular color. The image display apparatus determines the determination value X indicative of the degree of inclusion at which the achromatic data is included in the image data D1 and determines the light-emission start timings T1 and T2 of the areas of the backlight 15 in accordance with the determination value X. The image display apparatus thus switches, in response to the characteristics of the image data D1, between placing priority on controlling of the coloring and placing priority on improvement of the video display performance. The viewer may thus be precluded from visibly recognizing the ghost and the video edge mixed with the particular color.

The determination circuit 21 calculates the count CNT of the achromatic data included in the image data D1 of one frame and calculates as the determination value X the ratio of frames, each frame having the count CNT higher than the threshold TH, to the latest frames (M frames). In this way, the determination circuit 21 may determine the determination value X indicative of the degree of inclusion at which the achromatic data is included in the image data D1. As the determination value X is higher, the determination circuit 21 increases the difference between the light-emission start timings T1 and T2 of the areas when the areas are sequentially controlled to the light-emission state. The determination circuit 21 thus switches, in response to the characteristics of the image data D1, between placing priority on controlling of the coloring and placing priority on improvement of the video display performance. The viewer may thus be precluded from visibly recognizing the ghost and the video edge mixed with the particular color.

The backlight driving circuit 13 segments the backlight 15 into the first and second areas. The determination circuit 21 determines the light-emission start timing T1 of the first area by dividing by the determination value X the light-emission start timing T1a of the first area with the determination value X at maximum (X=1) and the light-emission start timing T1b of the first area with the determination value X at minimum (X=0). The determination circuit 21 also determines the light-emission start timing T2 of the second area by dividing by the determination value X the light-emission start timing T2a of the second area with the determination value X at maximum and the light-emission start timing T2b of the second area with the determination value X at minimum. In this way, when the backlight 15 is segmented into the two areas, the light-emission timings of the areas may be easily determined.

The image display apparatus further includes the gradation converting circuit 22 that performs gradation conversion for overdrive on the image data D1. In response to the determination value X, the gradation converting circuit 22 varies the degree of emphasis on the time change of the image data D1 in response to the determination value X. The gradation converting circuit 22 increases the degree of emphasis on the time change of the image data D1 as the determination value X is higher. In this way, the degree of emphasis on the time change of the image data D1 is appropriately switched in response to the degree of inclusion at which the achromatic data is included in the image data D1. The white-light light source is the white-light LED 17 including the blue-light LED 31, red-light phosphor 32, and green-light phosphor 33. The red-light phosphor 32 is the KSF phosphor.

The liquid-crystal display apparatus 1 of the embodiment may be modified. In the liquid-crystal display apparatus 1, the white-light light source included in the liquid-crystal panel 14 has the property that the afterglow of a red color persists longer than the afterglow of another color. In a modification of the liquid-crystal display apparatus, the white-light light source in the backlight may have the property that the afterglow of a green color persists longer than the afterglow of other colors (red and blue) or the afterglow of a blue color persists longer than the afterglow of other colors (red and green). The backlight 15 in the liquid-crystal display apparatus 1 includes multiple white-light LEDs 17 one-dimensionally arranged along the side of a light guide plate. Another modification of the liquid-crystal display apparatus may include the backlight including multiple white-light LEDs 17 and may have any configuration as long as the two areas are individually controlled. For example, the backlight may include multiple white-light LEDs 17 that are arranged two-dimensionally.

In the liquid-crystal display apparatus 1, the backlight driving circuit 13 performs two-segment alternate scan backlight driving. In one modification of the liquid-crystal display apparatus 1, the backlight driving circuit may perform N-segment alternate scan backlight driving (N is 3 or higher integer). Such modification may provide the same effect as the liquid-crystal display apparatus 1. Not only the liquid-crystal display apparatus including the backlight but also an image display apparatus may be implemented in a way similar to the way described above.

The present disclosure contains subject matter related to that disclosed in Japanese Priority Patent Application JP 2020-204932 filed in the Japan Patent Office on Dec. 10, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image display apparatus comprising:
a display panel including a plurality of pixels;
a backlight including a plurality of white-light light sources and emitting light onto a rear surface of the display panel;
a panel driving circuit driving the display panel;
a backlight driving circuit driving the backlight; and
a determination circuit determining image data that is input,
wherein the white-light light sources have persistence characteristics that cause afterglow of a particular color to persist longer than afterglow of another color,
wherein the backlight driving circuit segments the backlight into a plurality of areas and drives the backlight in a manner such that a time duration of performing control to cause the areas to sequentially be in a light-emission state at mutually different timings alternates with a time duration of performing control to cause all the areas to be in a non-light-emission state, and
wherein the determination circuit determines a determination value indicating a degree of inclusion at which achromatic data is included in the image data and determines a light-emission start timing of each of the areas in accordance with the determination value.

2. The image display apparatus according to claim 1, wherein the determination circuit determines a count of the achromatic data included in the image data of one frame and determines as the determination value a ratio of frames, each frame having the count higher than a threshold, from among a plurality of latest frames to the latest frames.

3. The image display apparatus according to claim 1, wherein as the determination value is higher, the determination circuit results in a larger difference between light-emission start timings of the areas when the areas are sequentially controlled to be in the light-emission state.

4. The image display apparatus according to claim 1, wherein the backlight driving circuit segments the backlight into a first area and a second area, and the determination circuit determines a light-emission start timing of the first area by dividing proportionally by the determination value a light-emission start timing of the first area when the determination value is at maximum and a light-emission start timing of the first area when the determination value is at minimum, and determines a light-emission start timing of the second area by dividing proportionally by the determination value a light-emission start timing of the second area when the determination value is at maximum and a light-emission start timing of the second area when the determination value is at minimum.

5. The image display apparatus according to claim 1, further comprising a gradation converting circuit that performs gradation conversion for overdrive on the image data, wherein the gradation converting circuit causes a degree of emphasis on a time change of the image data to vary in response to the determination value.

6. The image display apparatus according to claim 5, wherein as the determination value is higher, the gradation converting circuit results in a higher degree of emphasis on the time change of the image data.

7. The image display apparatus according to claim 1, wherein the backlight is configured to cause light leaked from one of the areas to diffuse to a far end of an adjacent area while intensity of leaked light decreases.

8. The image display apparatus according to claim 1, wherein the white-light light sources are white-light emitting diodes.

9. The image display apparatus according to claim 8, wherein each of the white-light emitting diodes comprises a blue-light emitting diode, a red-light phosphor, and a green-light phosphor.

10. The image display apparatus according to claim 9, wherein the red-light phosphor is KSF phosphor.

11. The image display apparatus according to claim 1, wherein the particular color is red.

12. The image display apparatus according to claim 1, wherein the display panel is a liquid-crystal panel.

13. An image display method of an image display apparatus including a display panel including a plurality of pixels and a backlight including a plurality of white-light light sources and emitting light onto a rear surface of the display panel, the image display method comprising:
driving the display panel;
driving the backlight; and
determining image data that is input,
wherein the white-light light sources have persistence characteristics that cause afterglow of a particular color to persist longer than afterglow of another color,
wherein the driving of the backlight includes segmenting the backlight into a plurality of areas and driving the backlight in a manner such that a time duration of performing control to cause the areas to sequentially be in a light-emission state at mutually different timings alternates with a time duration of performing control to cause all the areas to be in a non-light-emission state; and
wherein the determining of the image data includes determining a determination value indicating a degree of inclusion at which achromatic data is included in the image data and determining a light-emission start timing of each of the areas in accordance with the determination value.

14. The image display method according to claim 13, wherein the determining of the image data comprises determining a count of the achromatic data included in the image data of one frame and determining as the determination value a ratio of frames, each frame having the count higher than a threshold, from among a plurality of latest frames to the latest frames.

15. The image display method according to claim 13, wherein as the determination value is higher, the determining of the image data results in a larger difference between light-emission start timings of the areas when the areas are sequentially controlled to be in the light-emission state.

16. The image display method according to claim 13, wherein the driving of the backlight comprises segmenting the backlight into a first area and a second area, and the determining of the image data includes: determining a light-emission start timing of the first area by dividing proportionally by the determination value a light-emission start timing of the first area when the determination value is at maximum and a light-emission start timing of the first area when the determination value is at minimum; and determining a light-emission start timing of the second area by dividing proportionally by the determination value a light-emission start timing of the second area when the determination value is at maximum and a light-emission start timing of the second area when the determination value is at minimum.

17. The image display method according to claim 13, further comprising performing gradation conversion for overdrive on the image data, wherein the performing of the gradation conversion includes causing a degree of emphasis on a time change of the image data to vary in response to the determination value.

18. The image display method according to claim 13, wherein the white-light light sources are white-light emitting diodes.

19. The image display method according to claim 18, wherein each of the white-light emitting diodes comprises a blue-light emitting diode, a red-light phosphor, and a green-light phosphor.

20. The image display method according to claim 19, wherein the red-light phosphor is KSF phosphor.
